(19) United States
(12) Patent Application Publication
(10) Pub. No.: US 2003/0068144 A1
(43) Pub. Date: Apr. 10, 2003

(54) Optical fiber deployment tube

(76) Inventors: Patrick J. Burke, Corning, NY (US); William J. Miller, Horseheads, NY (US); Mark L. Morrell, Horseheads, NY (US)

Correspondence Address: CORNING INCORPORATED, SP-TI-3-1, CORNING, NY, 14831

(21) Appl. No.: 09/974,360

(22) Filed: Oct. 10, 2001

(51) Int. Cl. G02B 6/00

(52) U.S. Cl. 385/100; 385/147

(57) ABSTRACT

An optical fiber deployment tube including an outer tube having a through opening, and an inner fiber guide positioned therein, the inner fiber guide having a plurality of guide members with inner surfaces that form an inner opening for feeding the optical fiber therethrough, the inner surfaces being adapted to guide the optical fiber. In one embodiment, the adjacent guide members define a debris gap. The plurality of guide members are preferably metallic and the inner surfaces of the plurality of guide members are rounded. In another embodiment, a method for deploying an optical fiber is provided including the steps of providing an optical fiber deployment tube having a discontinuous inner surface, inserting the optical fiber, and feeding the optical fiber through the optical fiber deployment tube, where the inner surface of the optical fiber deployment tube guides the optical fiber.

### BACKGROUND OF THE INVENTION

1. Field of the Invention

The present invention is directed to tubes for deploying optical fibers from one location to another.

2. Description of Related Art

In optical fiber processing such as in manufacture of optical couplers, optical fibers must be conveyed from one location to another such as from the supply reel to an optical fiber processing station, or from one optical fiber processing station to another optical fiber processing station. Typically, this is attained by feeding the optical fiber through a deployment tube which guides the fiber therein to the desired location. The guide tubes provide a confined path through which the optical fiber can be conveyed. U.S. Pat. No. 6,092,394 to Backer et al. is noted for disclosing the use of such deployment tubes to convey optical fiber from one location to another. Backer et al. also discloses that T-fittings may be provided along the deployment tubes for injecting a gas such as nitrogen, air or the like into the deployment tubes. Backer et al. notes that the gas flowing out of the deployment tube blows dust and debris from the optical fiber before the optical fiber enters the deployment tubes. In addition, Backer et al. further discloses that the gas flowing within the deployment tubes lowers the friction between the guide tubes and the optical fibers.

However, despite the advantages of injecting a gas into the deployment tubes, limitations in use of such deployment tubes still remain due to various characteristics of the optical fibers and the deployment tubes as recognized by the present inventors and discussed herein below.

### SUMMARY OF THE INVENTION

The present inventors have found that despite the advantages of reduced friction by injecting gas into the deployment tubes, it is still difficult to feed the optical fibers through the prior art deployment tubes. In particular, the present inventors have found that due to the frictional contact between the optical fiber and the interior of the deployment tube, a static electric charge builds up as the optical fiber is conveyed through the prior art deployment tube. This static build-up causes the optical fiber to cling to the interior of the deployment tube, thus making conveyance of the optical fiber through the deployment tube difficult. The static build-up also increases the friction of the fiber coating against the deployment tubes, which can damage the optical fiber. Such static build-up has been found to be especially prevalent if the deployment tube is made from conventional material such as plastic. Therefore, there exists an unfulfilled need for an improved optical fiber deployment tube which will minimize the above described problems of prior art deployment tubes.

In view of the foregoing, the present invention provides an optical fiber deployment tube having the advantage of facilitating guiding of the optical fiber.

Another advantage of the present invention is in providing such an optical fiber deployment tube that minimizes contact area with the optical fiber.

Still another advantage of the present invention is in providing such an optical fiber deployment tube which minimizes static charge build up.

Yet another advantage of the present invention is in providing such an optical fiber deployment tube with debris gap therein.

Another advantage of the present invention is in providing such an optical fiber deployment tube which is economical.

In accordance with the present invention, an optical fiber deployment tube is provided including an outer tube having elongated length dimension and a through opening, and an inner fiber guide positioned in the through opening of the outer tube to extend along the elongated length dimension of the outer tube, the inner fiber guide having a plurality of guide members with inner surfaces that form an inner opening for feeding the optical fiber therethrough, the inner surfaces being adapted to guide the optical fiber as the optical fiber is fed through the inner opening.

In accordance with one embodiment of the present invention, the adjacent guide members define a debris gap. The plurality of guide members are preferably metallic in one embodiment and the inner surfaces of the plurality of guide members are rounded in another embodiment. In another embodiment, a gas is injected to facilitate feeding of the optical fiber through the inner fiber guide.

In accordance with still another embodiment of the present invention, the inner fiber guide of the optical fiber deployment tube includes at least one spring. In this regard, the spring is a coil spring in one preferred embodiment and the plurality of guide members are the coil loops of the coil spring. In another embodiment, the coil spring is a compression spring having a sufficient helix angle to provide a debris gap in each of the plurality of coil loops. Each of the plurality of the coil loops preferably has a circular cross sectional area in one embodiment. In another embodiment, a gas is injected to facilitate feeding of the optical fiber through the inner fiber guide.

In accordance with another aspect of the present invention, a method for deploying an optical fiber from one location to another is provided, the method including the steps of providing an optical fiber deployment tube having elongated length dimension and an inner surface which is discontinuous along the elongated length dimension, inserting an optical fiber through the optical fiber deployment tube, and feeding the optical fiber through the optical fiber deployment tube from one location to another location, where the inner surface of the optical fiber deployment tube guides the optical fiber.

In accordance with one embodiment of the present method, the discontinuous interior surface is formed by a plurality of guide members. In one embodiment, the guide members are rounded and the method further includes the step of forming a debris gap between adjacent guide members. In another embodiment, the plurality of guide members are coil loops of a coil spring. In this regard, the coil spring is preferably a metallic compression spring having a sufficient helix angle to provide a debris gap in each of the plurality of coil loops. In still another embodiment, the present method further includes the step of injecting a gas into the optical fiber deployment tube to facilitate feeding of the optical fiber.

These and other advantages and features of the present invention will become more apparent from the following detailed description of the preferred embodiments of the present invention when viewed in conjunction with the accompanying drawings.

### BRIEF DESCRIPTION OF THE DRAWINGS

FIG. 1 is a schematic illustration of an optical fiber deployment tube in accordance with one embodiment of the present invention being used in an optical fiber processing apparatus.

FIG. 2 is a segmented assembly view of an optical fiber deployment tube in accordance with one embodiment of the present invention.

FIG. 3 is a partially sectioned view of the optical fiber deployment tube shown in FIG. 2.

FIG. 4 is a cross sectional view of the optical fiber deployment tube of FIG. 2 as viewed along 4-4.

FIG. 5 is a partially sectioned view of an optical fiber deployment tube in accordance with another embodiment of the present invention.

FIG. 6 is a flow diagram showing a method for deploying an optical fiber from one location to another in accordance with one embodiment of the present invention.

### DETAILED DESCRIPTION OF THE PREFERRED EMBODIMENT

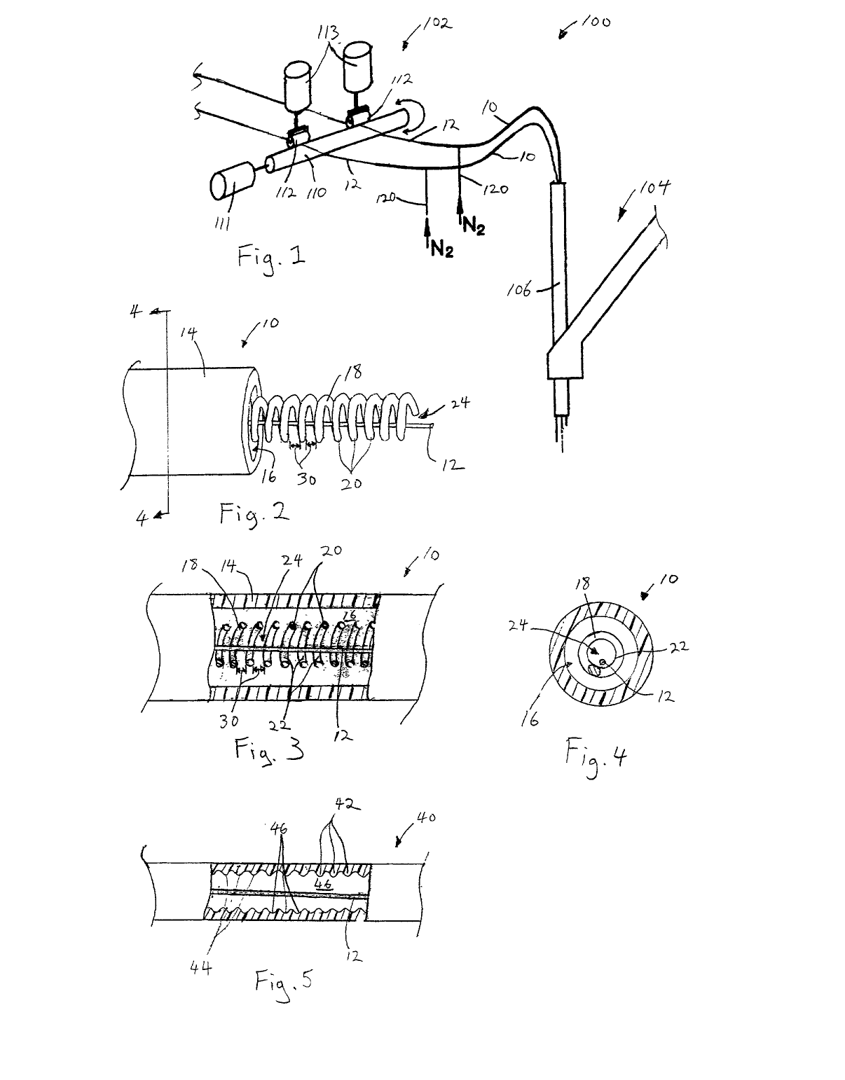

FIG. 1 is a schematic illustration of optical fiber deployment tubes 10 in accordance with one embodiment of the present invention being used in an optical fiber processing apparatus 100 where optical fibers 12 are conveyed from feed mechanism 102 to a fiber insertion apparatus 104. It should initially be noted that whereas in the illustrated figure described below, the deployment tubes 10 are used to convey the optical fibers 12 from the feed mechanism 102 to the fiber insertion apparatus 104, the deployment tubes 10 in accordance with the present invention can be used to convey optical fibers from any location to another. In this regard, the deployment tubes 10 can be used to convey optical fibers from a supply reel to an optical fiber processing station, between optical fiber processing stations, or even within one optical fiber processing station. Thus, FIG. 1 illustrates merely one application of the optical fiber deployment tubes 10 in accordance with the present invention and the present invention should not be limited thereto.

As can be seen in FIG. 1, the optical fibers 12 are fed through the feed mechanism 102 which may include a turned roller 110 driven by motor 111 and idler rollers 113 which are actuable via cylinders 113. When the cylinders 113 are actuated, the idler rollers 113 engage the turned roller 110 to thereby feed the optical fibers 12 through the optical fiber deployment tubes 10. In the illustrated embodiment, the deployment tubes 10 convey the optical fibers 12 to a support arm 106 of a fiber insertion apparatus 104, only portion of which is shown. The fiber insertion apparatus 104 can be used to insert the optical fibers 12 into a glass tube (not shown) for making an optical coupler or other optical component.

As will be evident from the discussion herein below, the optical fiber deployment tubes 10 in accordance with the present invention facilitates guiding of the optical fiber and minimizes contact area with the optical fiber 12. In addition, the deployment tubes 10 minimizes static charge build-up while providing debris gap. Moreover, the present invention provides these advantages in an economical manner.

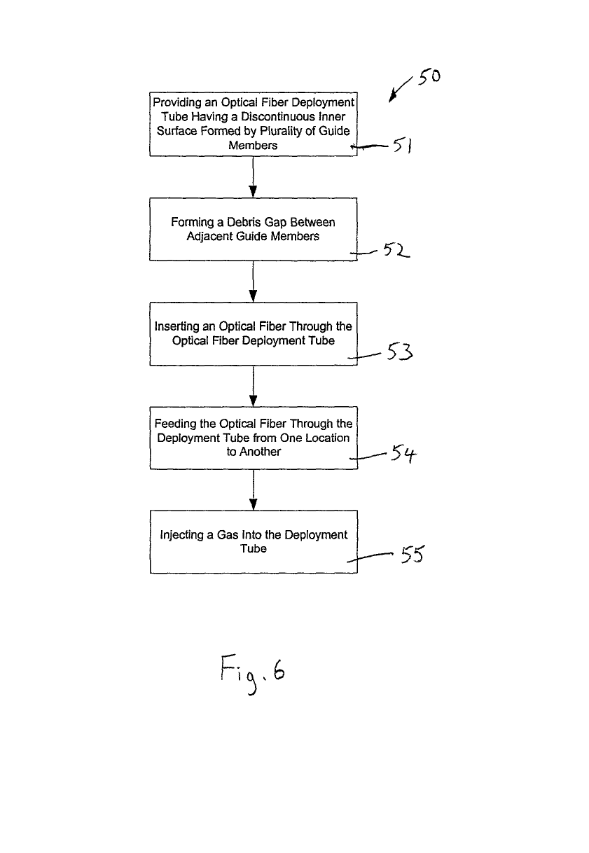

FIG. 2 is a segmented assembly view of an optical fiber deployment tube 10 in accordance with one embodiment of the present invention which shows the detailed construction of the deployment tube 10. FIG. 3 is a partially sectioned view of a midsection of the deployment tube 10 while FIG. 4 is a cross sectional view of the optical fiber deployment tube of FIG. 2 as viewed along 4-4. The present embodiment can be easily understood by viewing these figures together with the discussion below.

As can be seen in these figures, in accordance with the illustrated embodiment, the optical fiber deployment tube 10 includes an outer tube 14 having elongated length dimension and a through opening 16, the elongated length of the deployment tube 10 most clearly being illustrated in FIG. 1. Referring again to FIGS. 2-4, the illustrated embodiment of the deployment tube 10 also includes an inner fiber guide 18 positioned in the through opening 16 of the outer tube 14 to extend along the elongated length dimension of the outer tube 14. The inner fiber guide 18 has a plurality of guide members 20 with inner surfaces 22 that form and define an inner opening 24 for feeding the optical fiber 12 therethrough, the inner surfaces 22 being adapted to guide the optical fiber 12 as it is fed through the inner opening 24. It should be noted that whereas the various figures show an optical fiber 12, the optical fiber 12 is actually not a part of the invention but is merely illustrated to show the context of how the optical fiber deployment tube 10 in accordance with the present invention is used.

As can be seen, in the illustrated embodiment of FIGS. 2-4, the inner fiber guide 18 is a coil spring and the plurality of guide members 20 are coil loops of the coil spring. By providing an inner fiber guide 18 which is a coil spring, various advantages can be realized in a very economic manner. In particular, the coil spring is preferably a compression spring having a sufficient helix angle to provide a debris gap 30 in each of the plurality of coil loops. This debris gap 30 allows any debris or contaminants brought into the deployment tube 10 to be removed from the inner opening 24 where the optical fiber 12 is conveyed, to a portion of the through opening 16 between fiber guide 18 and the outer tube 14. This feature minimizes the amount of debris that is conveyed by the optical fiber 12 to an optical fiber processing station or any other location which may be sensitive to such debris and contamination therefrom.

Moreover, by providing a debris gap 30 between the plurality of guide members 20, the contact area between the optical fiber 12 and the deployment tube 10 is also reduced. More specifically, because the inner surfaces 22 are provided in a discontinuous manner along the elongated length dimension of the deployment tube 10, the contact area between the optical fiber 12 and the fiber guide 18 is reduced. In addition, the inner surfaces 22 of the plurality of guide members 20 are preferably rounded. For instance, in the illustrated embodiment where the inner fiber guide 18 is a coil spring, each of the plurality of coil loops preferably have a circular cross sectional area. As can be appreciated, if the guide members 20 are rounded, the optical fiber 12 essentially makes a point contact with the guide members 20 since the optical fiber 12 itself, generally has a circular cross section. This allows the contact area between the optical fiber 12 and the fiber guide 18 to be further reduced. The reduction in the contact area between the optical fiber 12 and the deployment tube 10 of the present invention ultimately facilitates the feeding and conveyance of the optical fiber 12 in the manner described below.

In particular, the deployment tubes of the prior art are typically made of a flexible plastic that allows the deployment tubes to be routed from one location to another. However, the above discussed frictional contact between the outer cladding of the optical fiber and the prior art deployment tube causes static energy to build which in turn, causes the optical fiber to cling to the prior art deployment tube thereby making feeding and conveyance of the optical fiber through the deployment tube even more difficult. By minimizing the contact area between the optical fiber 12 and the deployment tube 10, this static build up is greatly minimized.

In the above regard, the present inventors have found that metallic guide members 20 minimize the generation and build-up of static between the optical fiber 12 and the deployment tube 10. By providing plurality of guide members 20 that are metallic, static build-up between the optical fiber and the deployment tube 10 in accordance with the present embodiment is virtually eliminated. In addition, because in the illustrated embodiment, the plurality of guide members 20 are coil loops of the coil spring, the deployment tube 10 maintains its flexibility so that the deployment tube 10 can be routed from one location to another.

In the above described manner, optical fiber deployment tube 10 in accordance with the above discussed embodiment of the present invention minimizes the contact area between the optical fiber 12 and the deployment tube 10 to thereby reduce static build-up and greatly facilitates the conveyance of the optical fiber 12 in the deployment tube 10. Furthermore, these advantages can be realized in a very economical manner using a coil spring which is very inexpensive to manufacture or purchase. Of course, it should be noted that in other embodiments of the present invention, the guide members 20 need not be rounded, be a coil spring, or be metallic. However, it should be evident from the discussion above how such an embodiment of the present invention provides a particularly useful optical fiber deployment tube which facilitates the conveyance of optical fiber 12 from one location to another.

Referring again to FIGS. 1-4, the optical fiber deployment tube 10 in accordance with the illustrated embodiment is used in conjunction with gas injection tubes 120 for injecting a gas such as nitrogen N₂ or air in the manner shown. The gas injection tubes 120 are connect to the optical fiber deployment tube 10 via T-fittings (not shown) or in any other appropriate manner. The gas that is injected into the deployment tube facilitates feeding of the optical fiber 12 through the deployment tube 10 and also aids in reducing the amount of debris brought into the deployment tube 10 as previously explained. Moreover, the gas that is injected also cleans out the debris in the portion of the opening 16 between fiber guide 18 and the outer tube 14. In this manner, the maintenance requirements of the deployment tube 10 can be reduced.

FIG. 5 is a partially sectioned view of an optical fiber deployment tube 40 in accordance with another embodiment of the present invention. As can be seen, the illustrated embodiment of the deployment tube 40 differs from the previously described embodiment in that the plurality of guide members 42 are integrally formed on the deployment tube 40 and a separate fiber guide is not provided. As can be seen, the plurality of guide members 42 are formed as ridges along the interior of the deployment tube 40. The plurality of guide members 42 have inner surfaces 44 that provide a discontinuous inner surface and define an inner opening 46 for feeding the optical fiber 12 therethrough. The inner surfaces 44 are preferably rounded as shown and are adapted to guide the optical fiber 12 as it is fed through the inner opening 46. The adjacent inner surfaces 44 of the guide members 42 form debris gap 46 therein between for allowing debris or other contaminants to be collected without impeding the conveyance of the optical fiber 12 through the deployment tube 40. Of course, in the illustrated embodiment, the guide members 42 are not metallic and the advantages described previously in virtually eliminating static build-up is not fully realized. However, as also described previously, by providing a discontinuous inner surface, the contact area between the optical fiber 12 and the deployment tube 40 is still significantly reduced which correspondingly reduces the static build up. Again, it should be noted that whereas the embodiment of FIG. 5 also shows an optical fiber 12, the optical fiber 12 is actually not a part of the invention but is merely illustrated to show the context of how the optical fiber deployment tube 40 is used.

In view of the above discussion, it should also be evident that another aspect of the present invention is to provide a method for deploying an optical fiber from one location to another. In this regard, FIG. 6 shows a flow diagram 50 showing a method for deploying an optical fiber in accordance with one embodiment of the present method. As can be seen, the method provides an optical fiber deployment tube having a discontinuous inner surface formed by a plurality of guide members in step 51. A debris gap is formed between the adjacent guide members in step 52. An optical fiber is inserted through the optical fiber deployment tube in step 53, and the optical fiber is fed through the optical fiber deployment tube from one location to another location in step 54. In addition, the illustrated method of FIG. 6 shows an optional step of injecting a gas into the optical fiber deployment tube to facilitate feeding of the optical fiber. As can be readily appreciated, the inner surface of the optical fiber deployment tube guides the optical fiber as described previously. Of course, the plurality of guide members are preferably rounded and are coil loops of a metallic compression spring as also described previously so that additional benefits previously described can be realized.

Therefore, it should now be evident how the optical fiber deployment tube and method of deploying optical fibers in accordance with the present invention facilitates guiding of the optical fiber while minimizing contact area and the associated static charge build-up while providing debris gap. Moreover, it should also be evident how the present invention provides these advantages in an economical manner.

While various embodiments in accordance with the present invention have been shown and described, it is understood that the invention is not limited thereto. The present invention may be changed, modified and further applied by those skilled in the art. Therefore, this invention is not limited to the detail shown and described previously, but also includes all such changes and modifications.

We claim:

1. An optical fiber deployment tube comprising:
an outer tube having elongated length dimension and a through opening; and
an inner fiber guide positioned in the through opening of the outer tube to extend along the elongated length dimension of the outer tube, the inner fiber guide having a plurality of guide members with inner surfaces that form an inner opening for feeding the optical fiber therethrough, the inner surfaces being adapted to guide the optical fiber as the optical fiber is fed through the inner opening.

2. The optical fiber deployment tube of claim 1, wherein adjacent guide members of the plurality of guide members define a debris gap.

3. The optical fiber deployment tube of claim 1, wherein the plurality of guide members are metallic.

4. The optical fiber deployment tube of claim 1, wherein the inner surfaces of the plurality of guide members are rounded.

5. The optical fiber deployment tube of claim 1, wherein a gas is injected into the outer tube of the optical fiber deployment tube to facilitate feeding of the optical fiber through the inner fiber guide.

6. The optical fiber deployment tube of claim 1, wherein the inner fiber guide includes at least one spring.

7. The optical fiber deployment tube of claim 6, wherein the at least one spring is a coil spring and the plurality of guide members are coil loops of the coil spring.

8. The optical fiber deployment tube of claim 7, wherein the at least one coil spring is a compression spring having a sufficient helix angle to provide a debris gap in each of the plurality of coil loops.

9. The optical fiber deployment tube of claim 8, wherein the at least one coil spring is metallic.

10. The optical fiber deployment tube of claim 9, wherein each of the plurality of coil loops have a circular cross sectional area.

11. The optical fiber deployment tube of claim 10, wherein a gas is injected into the outer tube of the optical fiber deployment tube to facilitate feeding of the optical fiber through the inner fiber guide.

12. The optical fiber deployment tube of claim 7, wherein the at least one coil spring is metallic.

13. The optical fiber deployment tube of claim 7, wherein each of the plurality of coil loops have a circular cross sectional area.

14. The optical fiber deployment tube of claim 7, wherein a gas is injected into the outer tube of the optical fiber deployment tube to facilitate feeding of the optical fiber through the inner fiber guide.

15. A method for deploying an optical fiber from one location to another comprising the steps of:
providing an optical fiber deployment tube having elongated length dimension and an inner surface which is discontinuous along the elongated length dimension;
inserting an optical fiber through the optical fiber deployment tube; and
feeding the optical fiber through the optical fiber deployment tube from one location to another location;
wherein the inner surface of the optical fiber deployment tube guides the optical fiber.

16. The method of claim 15, wherein the discontinuous interior surface is formed by a plurality of guide members.

17. The method of claim 16, wherein each of the plurality of guide members are rounded.

18. The method of claim 16, further including the step of forming a debris gap between adjacent guide members.

19. The method of claim 16, wherein the plurality of guide members are coil loops of a coil spring.

20. The method of claim 19, wherein the coil spring is metallic.

21. The method of claim 19, wherein the coil spring is a compression spring having a sufficient helix angle to provide a debris gap in each of the plurality of coil loops.

22. The method of claim 15, further including the step of injecting a gas into the optical fiber deployment tube to facilitate feeding of the optical fiber.
